(19) United States
(12) Patent Application Publication
(10) Pub. No.: US 2006/0072563 A1
(43) Pub. Date: Apr. 6, 2006

(54) Packet processing

(76) Inventors: Greg J. Regnier, Portland, OR (US); Vikram A. Saletore, Olympia, WA (US); Gary L. McAlpine, Banks, OR (US); Ram Huggahalli, Portland, OR (US); Ravishankar Iyer, Hillsboro, OR (US); Ramesh G. Illikkal, Portland, OR (US); David B. Minturn, Hillsboro, OR (US); Donald Newell, Portland, OR (US); Srihari Makineni, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/959,488

(22) Filed: Oct. 5, 2004

(51) Int. Cl. H04L 12/56

(52) U.S. Cl. 370/389

(57) ABSTRACT

In general, the disclosure describes a variety of techniques that can enhance packet processing operations.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a protocol known as Transmission Control Protocol (TCP) provides “connection” services that enable remote applications to communicate. Behind the scenes, TCP handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. Frequently, an IP datagram is further encapsulated by an even larger packet such as a link layer frame (e.g., an Ethernet frame). The payload of a TCP segment carries a portion of a stream of data sent across a network by an application. A receiver can restore the original stream of data by reassembling the received segments. To permit reassembly and acknowledgment (ACK) of received data back to the sender, TCP associates a sequence number with each payload byte.

Many computer systems and other devices feature host processors (e.g., general purpose Central Processing Units (CPUs)) that handle a wide variety of computing tasks. Often these tasks include handling network traffic such as TCP/IP connections. The increases in network traffic and connection speeds have placed growing demands on host processor resources. To at least partially alleviate this burden, some have developed TCP Off-load Engines (TOE) dedicated to off-loading TCP protocol operations from the host processor.

### BRIEF DESCRIPTION OF THE DRAWINGS

FIG. 1 is a diagram of a computer system.

FIG. 2 is a diagram illustrating direct cache access.

FIGS. 3A-3B are diagrams illustrating fetching of data into a cache.

FIG. 4 is a diagram illustrating multi-threading.

FIG. 5A-5C are diagrams illustrating asynchronous copying of data.

FIG. 6-8 are diagrams illustrating processing of a received packet.

FIG. 9 is a diagram illustrating data structures used to store TCP Transmission Control Blocks (TCBs).

FIG. 10 is a diagram illustrating elements of an application interface.

FIG. 11 is a diagram illustrating a process to transmit a packet.

### DETAILED DESCRIPTION

Faster network communication speeds have increased the burden of packet processing on host systems. In short, more packets need to be processed in less time. Fortunately, processor speeds have continued to increase, partially absorbing these increased demands. Improvements in the speed of memory, however, have generally failed to keep pace. Each memory access that occurs during packet processing represents a potential delay as the processor awaits completion of the memory operation. Many network protocol implementations access memory a number of times for each packet. For example, a typical TCP/IP implementation performs a number of memory operations for each received packet including copying payload data to an application buffer, looking up connection related data, and so forth.

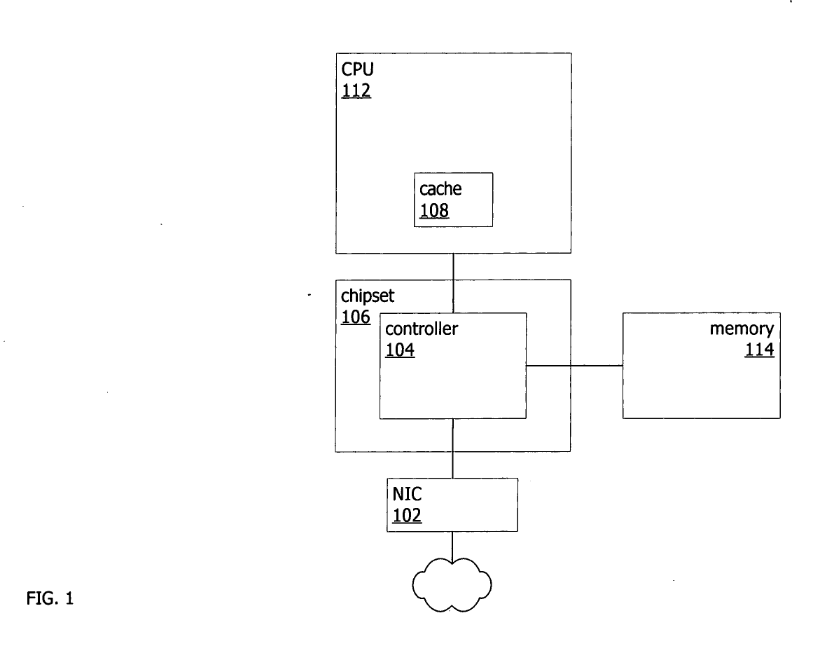

This description illustrates a variety of techniques that can increase the packet processing speed of a system despite delays associated with memory accesses by enabling the processor to perform other operations while memory operations occur. These techniques may be implemented in a variety of environments such as the sample computer system shown in FIG. 1. The system shown includes a Central Processing Unit (CPU) 112 and a chipset 106. The chipset 106 shown includes a controller hub 104 that connects the CPU 112 to memory 114 and other Input/Output (I/O) devices such as a network interface controller (NIC) (a.k.a. a network adaptor) 102.

As shown, the CPU 112 features an internal cache 108 that provides faster access to data than provided by memory 114. Typically, the cache 108 and memory 114 form an access hierarchy. That is, the cache 108 will attempt to respond to CPU 112 memory access requests using its small set of quickly accessible copies of memory 114 data. If the cache 108 does not store the requested data (a cache miss), the data will be retrieved from memory 114 and placed in the cache 108. Potentially, the cache 108 may victimize entries from the cache's 108 limited storage space to make room for new data.

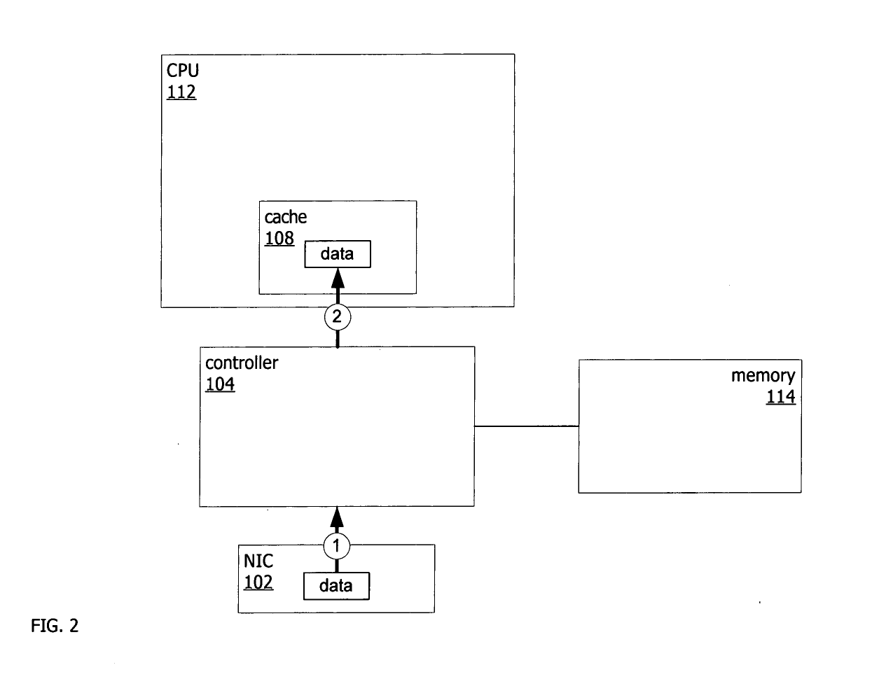

In a variety of packet processing operations, cache misses occur at predictable junctures. For example, conventionally, a NIC transfers received packet data to memory and generates an interrupt notifying the CPU. When the CPU initially attempts to access the received data, a cache-miss occurs, temporarily stalling processing as the packet data is retrieved from memory. FIG. 2 illustrates a technique that can potentially avert such scenarios.

In the example shown, the NIC 102 can cause direct placement of data in the CPU 112 cache 108 instead of merely storing the data in memory 114. When the CPU 112 attempts to access the data, a cache miss is less likely to occur and the ensuing memory 114 access delay can be avoided.

FIG. 2 depicts direct cache access as a two stage process. First, the NIC 102 issues a direct cache access request to the controller 104. The request can include the memory address and data associated with the address. The controller 104, in turn, sends a request to the cache 108 to store the data. The controller 104 may also write the data to memory 114. Alternately, the “pushed” data may be written to memory 114 when victimized by cache 108. Thus, storage of the packet data directly in the cache, unsolicited by the processor 112, can prevent the “compulsory” cache miss conventionally incurred by the CPU 112 after initial notification of received data.

Direct cache access may vary in other implementations. For example, the NIC 102 may be configured to directly access the cache 108 instead of using controller 104 as an intermediate agent. Additionally, in a system featuring multiple CPUs 112 and/or multiple caches 108 (e.g., L1 and L2 caches), the direct cache access request may specify the target CPU and/or cache 108. For example, the target CPU and/or cache 108 may be determined based on protocol information within the packet (e.g., a TCP/IP tuple identifying a connection). Pushing data into the relatively large last-level caches can minimize pre-mature victimization of cached data.

Though FIG. 2 depicts direct cache access to write packet (or packet related) data to the cache 108 after its initial receipt, direct cache access may occur at other points in the processing of a packet and on the behalf of agents other than NIC 102.

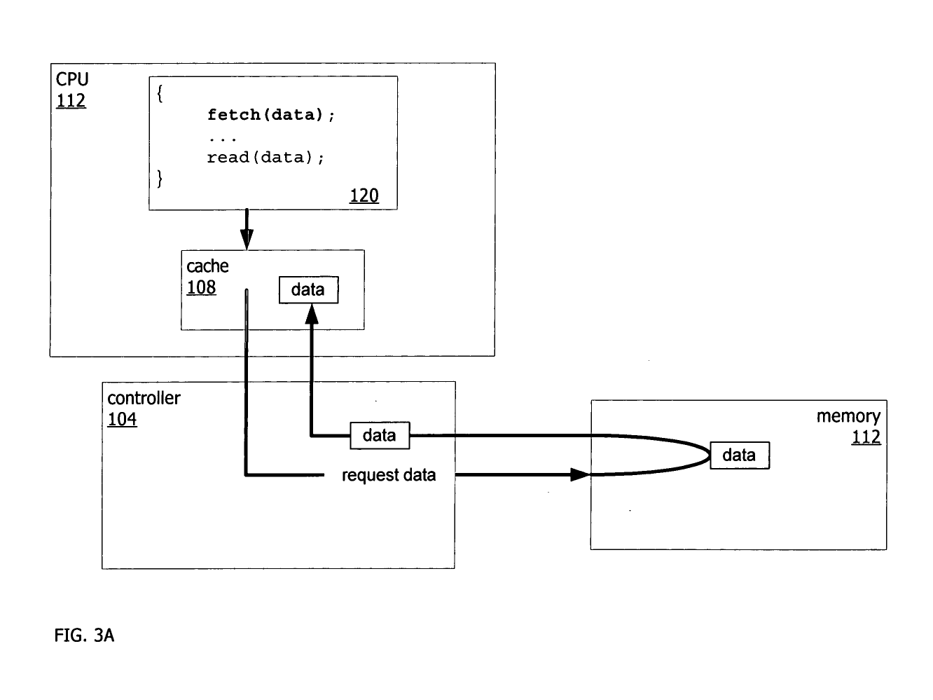

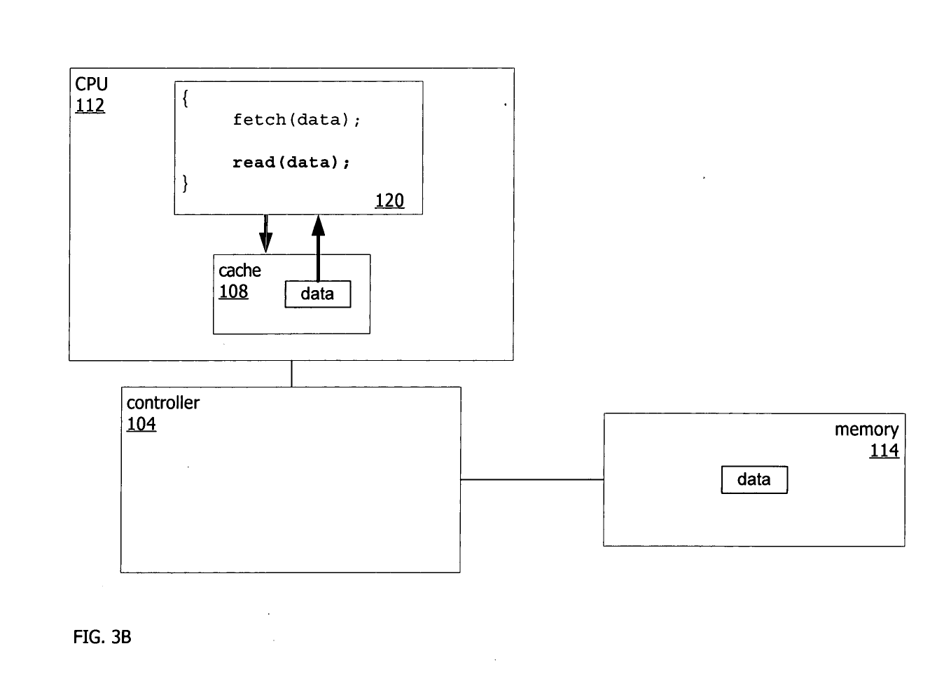

The technique shown in FIG. 2 can place data in the cache 108 before requested by the CPU 112, saving time that may otherwise be spent waiting for data retrieval from memory 114. FIGS. 3A and 3B illustrate another technique that can load data into the cache 108.

As shown, FIG. 3A lists instructions 120 executed by the CPU 112. For purposes of explanation, the instructions shown are high-level instructions instead of the binary machine code actually executed by the CPU 112. As shown, the code 120 includes a data fetch (bolded). This instruction causes the CPU 112 to issue a data fetch to the cache 108. Much like an ordinary read operation, the data fetch identifies address(es) which the cache 108 searches for. In the event of a miss, the cache 108 is loaded with the data associated with the requested address(es) from memory 114. Unlike a conventional read operation, however, the data fetch does not stall CPU 112 execution of the instructions 120, instead execution continues. Thus, other instructions (e.g., shown as ellipses) can proceed, avoiding processor cycles spent waiting for data to be fetched into the cache 108.

As shown in FIG. 3B, eventually the instructions 120 may access the fetched data. Assuming the data was not victimized by the cache 108 in the time between the fetch and the read, the cache 108 can quickly service the request without the delay associated with a memory 114 access. As illustrated in FIGS. 3A and 3B, the software data fetch gives a programmer or compiler finer control of cache 108 contents. Software fetch and direct cache access provide complementary capabilities that can provide a greater cache hit rate in both predictable circumstances (e.g., fetch instructions preload cache before data is needed) and for events asynchronous to code execution (e.g., placement of received packet data in a cache).

Direct cache access and fetching can be combined in a variety of ways. For example, instead of pushing data into the cache as described above, the NIC 102 can write packet data to memory 114 and issue a fetch command to the CPU. This variation can achieve a similar cache hit frequency.

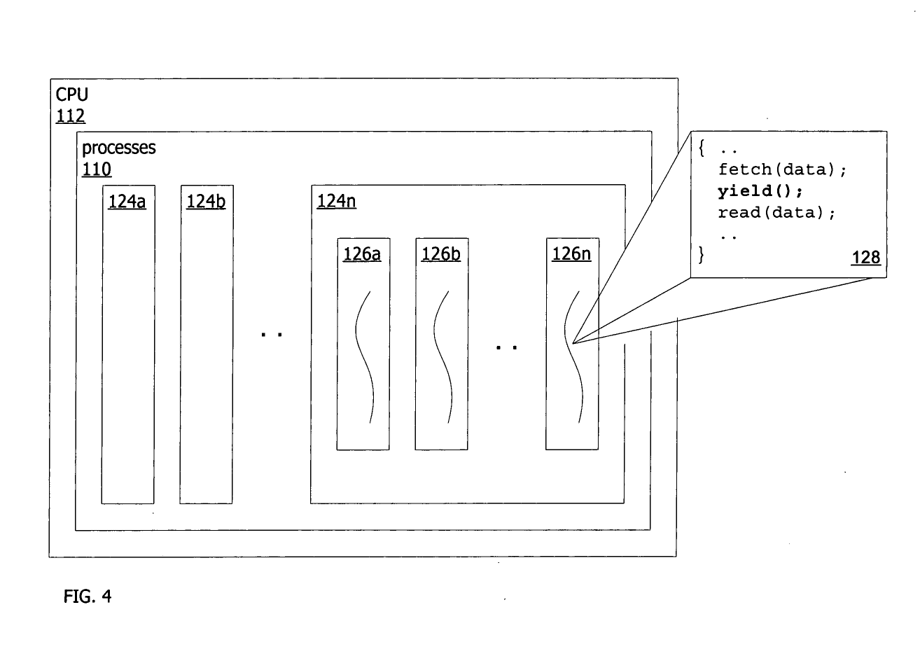

In FIGS. 3A and 3B, the data fetch enabled processing to continue while memory 114 operations proceeded. FIG. 4 illustrates another technique that can take advantage of processor cycles otherwise spent idly waiting for a memory operation to complete. In FIG. 4, the CPU 112 executes instructions of different threads 126. Each thread 126a-126n is an independent sequence of execution. More specifically, each thread features its own context data that defines the state of execution. This context includes a program counter identifying the last or next instruction to execute, the values of data (e.g., registers and/or memory) being used by a thread 126a-126n, and so forth.

Though CPU 112 generally executes instructions of one thread at a time, the CPU 112 can switch between the different threads, executing instructions of one thread and then another. This multi-threading can be used to mask the cost of memory operations. For example, if a thread yields after issuing a memory request, other threads can be executed while the memory operation proceeds. By the time execution of the original thread resumes, the memory operation may have completed.

A system may handle the thread switching in a variety of ways. For example, switching may occur in response to a software instruction surrendering CPU 112 execution of the thread 126n. For example, in FIG. 4, thread 126n code 128 features a yield instruction (bolded) that causes the CPU 112 to temporarily suspend thread execution in favor of another thread. As shown, the yield instruction is sandwiched by a preceding fetch and a following operation on the retrieved data. Again, the temporary suspension of thread 126n execution enables the CPU 112 to execute instructions of other threads while the fetch operation proceeds. A thread making many memory access requests may include many such yields. The explicit yield instruction provides multi-threading without additional mechanisms to enforce “fair” thread sharing of the CPU 112 (e.g., pre-emptive multi-threading). Alternately, the CPU 112 may be configured to automatically yield a thread after a memory operation until completion of the memory request.

A variety of context-switching mechanisms may be used in a multi-threading scheme. For example, a CPU 112 may include hardware that automatically copies/restores context data for different threads. Alternately, software may implement a “light-weight” threading scheme that does not require hardware support. That is, instead of relying on hardware to handle context save/restoring, software instructions can store/restore context data.

As shown in FIG. 4, the threads 126 may operate within a single operating system (OS) process 124n. This process 124n may be one of many active processes. For example, process 124a may be an application-level process (e.g., a web-browser) while process 124n handles transport and network layer operations.

A variety of software architectures may be used to implement multi-threading. For example, yielding execution control by a thread may write the thread's context to a cache and branch to an event handler that selects and transfers control to a different thread. Thread 126a scheduling may be performed in a variety of ways, for example, using a round-robin or priority based scheme. For instance, a scheduling thread may maintain a thread queue that appends recently “yielded” threads to the bottom of the queue. Potentially, a thread may be ineligible for execution until a pending memory operation completes.

While each thread 126a-126n has its own context, different threads may execute the same set of instructions. This allows a given set of operations to be “replicated” to the proper scale of execution. For instance, a thread may be replicated to handle received TCP/IP packets for one or more TCP/IP connections.

Thread activity can be controlled using “wake” and “sleep” scheduling operations. The wake operation adds a thread to a queue (e.g., a “RunQ”) of active threads while a sleep operation removes the thread from the queue. Potentially, the scheduling thread may fetch data to be accessed by a wakened thread.

The threads 126a-126n may use a variety of mechanisms to intercommunicate. For example, a thread handling TCP receive operations for a connection and a thread handling TCP transmit operations for the same connection may both vie for access to the connection's TCP Transmission Control Block (TCB). To address contention issues, a locking mechanism may be provided. For example, the event handler may maintain a queue for threads requesting access to resources locked by another thread. When a thread requests a lock on a given resource, the scheduler may save the thread's context data in the lock queue until the lock is released.

In addition to locking/unlocking, threads 126 may share a commonly accessible queue that the threads can push/pop data to/from. For example, a thread may perform operations on a set of packets and push the packets onto the queue for continued processing by a different thread.

Fetching and multi-threading can complement one another in a variety of packet processing operations. For example, a linked list may be navigated by fetching the next node in the list and yielding. Again, this can conserve processing cycles otherwise spent waiting for the next list element to be retrieved.

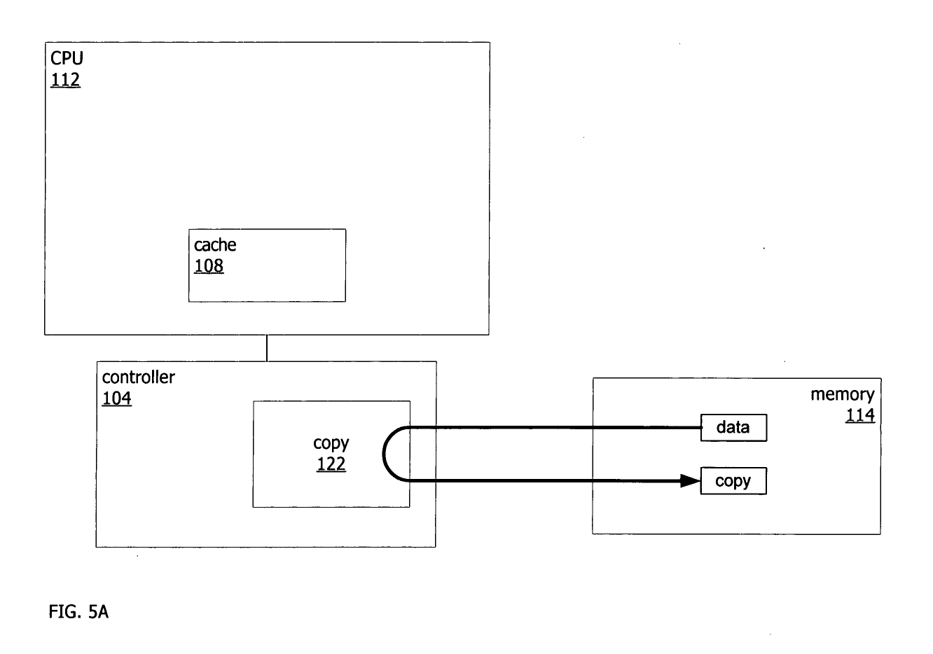

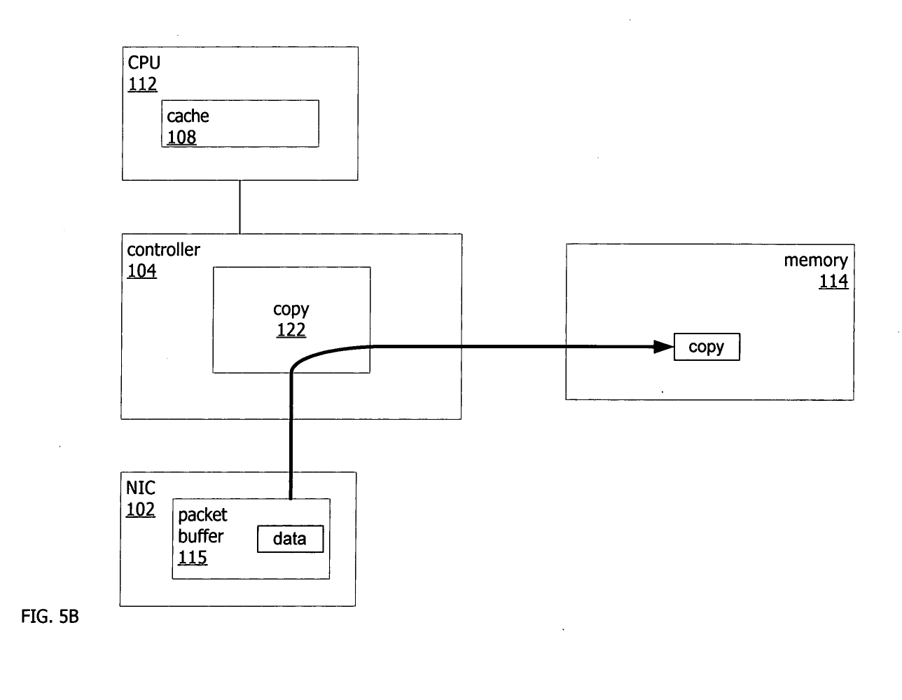

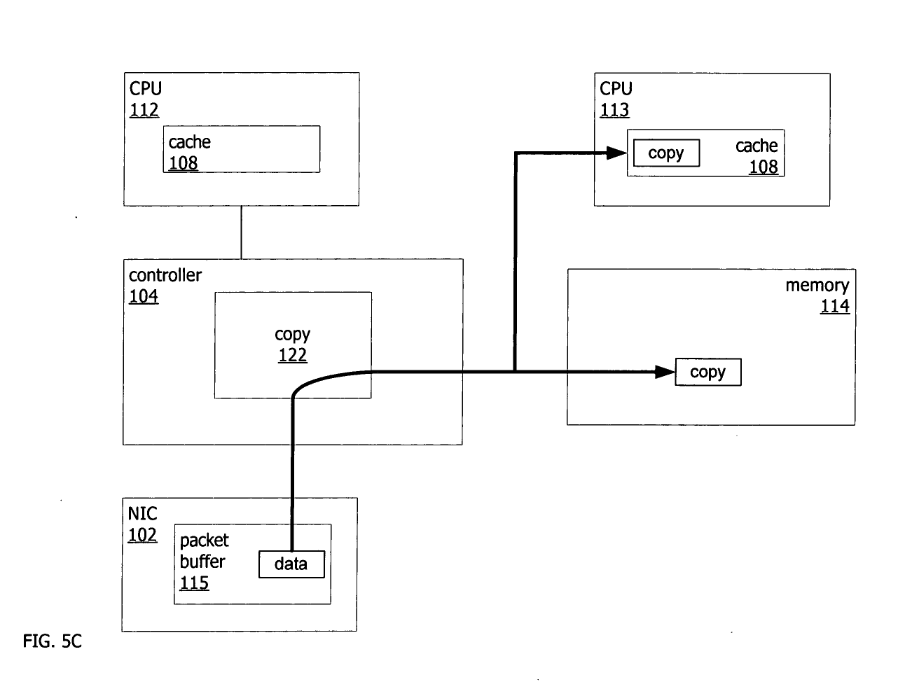

As shown, direct cache access, fetching, and multi-threading can reduce the processing cost of memory operations by continuing processing while a memory operation proceeds. Potentially, these techniques may be used to speed copy operations that occur during packet processing (e.g., copying reassembled data to an application buffer). Conventionally, a copy operation proceeds under the explicit control of the CPU 112. That is, data is read from memory 114 into the CPU 112, then written back to memory 114 at a different location. Depending on the amount of data being copied, such as a packet with a large payload, this can tie up a significant amount of processing cycles. To reduce the cost of a copy, packet data may be pushed into the cache or fetched before being written to its destination. Alternately, FIG. 5A-5C illustrates a system that includes copy circuitry 122 that, in response to an initial request, independently copies data, for example, from a first set of locations in the memory 114 to a second set of locations in the memory 114 or directly to the cache of a CPU 112 assigned to executing the application to which the packet is destined.

The copy circuitry 122 may perform asynchronous, independent copying from a variety of source and target devices (e.g., to/from memory 114, NIC 102, and cache 108). For example, FIG. 5A illustrates the data being copied from a first set of locations in the memory 114 to a second set of locations in the memory 114; FIG. 5B illustrates the data being copied from a first set of locations in the packet buffer 115 to a second set of locations in the memory 114; and FIG. 5C illustrates the data being copied from a first set of locations in the packet buffer 115 directly to the cache 108 of the CPU 113 running the application to which the packet is destined. FIG. 5C shows the copy may also be written to both the cache 108 and the memory 114 during the same copy operation in order to ensure coherency between the cache and memory. Though the packet processing CPU 112 may initiate the copy, reading and writing of data may take place concurrently with other execution in CPU 112 and CPU 113. The instruction initiating the copy may include the source and target devices (e.g., memory, cache, processor, or NIC), source and target device addresses, and an amount of data to copy.

To identify completion of the copy, the circuitry 122 can write completion status into a predefined memory location that can be polled by the CPU 112 or the circuitry 122 can generate a completion signal. Potentially, the circuitry 122 can handle multiple on-going copy operations simultaneously, for example, by pipelining copy operations.

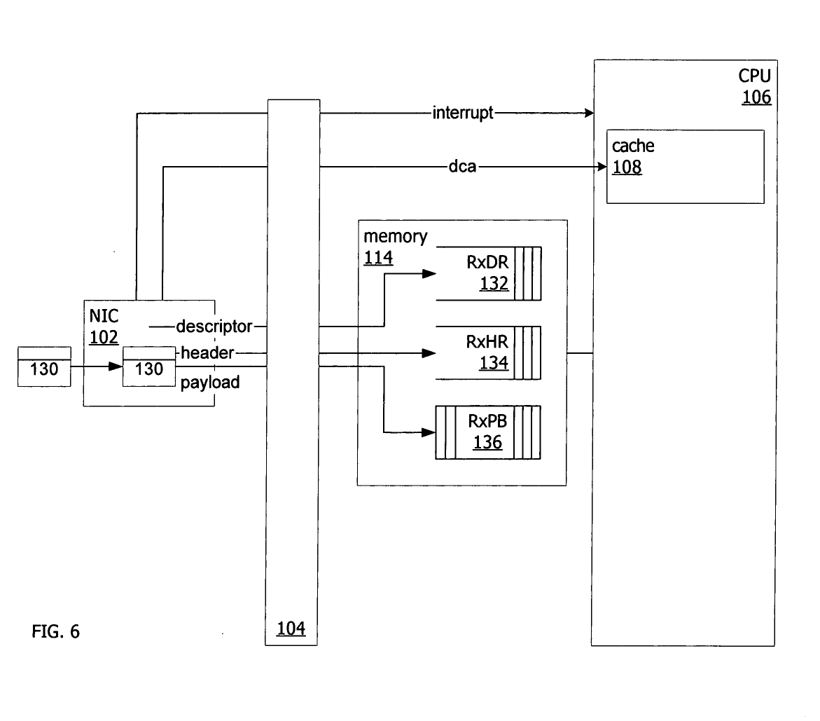

FIGS. 2-5 illustrated different techniques that can be used in a packet processing scheme. These different mechanisms can be used and combined in a wide variety of ways and in a wide variety of network protocol implementations. To illustrate, FIGS. 6-11 depict a sample scheme to process TCP/IP packets.

As shown in FIG. 6, in this sample implementation, the NIC 102 performs a variety of operations in response to receiving a packet 130. Generally, a NIC 102 includes an interface to a communications medium (e.g., a wire or wireless interface) and a media access controller (MAC). As shown, the NIC 102, after de-encapsulating a packet from within its link-layer frame, the NIC 102 splits the packet into its constituent header and payload portions. The NIC 102 enqueues the header into a received header queue 134 (RxHR) and may also store the packet payload into a buffer allocated from a pool of packet buffers 136 (RxPB) in memory 114. Alternatively, the NIC 102 may hold the payload in its packet buffer 115 until the header has been processed and the destination application has been determined. The NIC 102 also prepares and enqueues a packet descriptor into a packet descriptor queue 132 (RxDR). The descriptor can include a variety of information such as the address of the buffer(s) 136 storing the packet 130 payload. The NIC 102 may also perform TCP operations such as computing a checksum of the TCP segment and/or performing a hash of the packet's 130 TCP “tuple” (e.g., a combination of the packet's IP source and destination addresses and the TCP source and destination ports). This hash can later be used in looking up the TCB block associated with the packet's connection. The hash, checksum, and other information can be included in the enqueued descriptor. For example, the descriptor and header entries for the packet may be stored in the same relative positions within their respective queues 132, 134. This enables fast location of the header entry based on the location of the descriptor entry and vice versa.

The NIC 102 data transfers may occur via Direct Memory Access (DMA) to memory 114. To reduce “compulsory” cache misses, the NIC 102 also may also (or alternately) initiate a direct cache access to store the packet's 130 descriptor and header in cache 108 in anticipation of imminent CPU 112 processing of the packet 130. As shown, the NIC 102 notifies the CPU 112 of the packet's 130 arrival by signaling an interrupt. Potentially, the NIC 102 may use an interrupt moderation scheme to notify the CPU 112 after arrival of multiple packets. Processing batches of multiple packets enables the CPU 112 to better control cache contents by fetching data for each packet in the batch before processing.

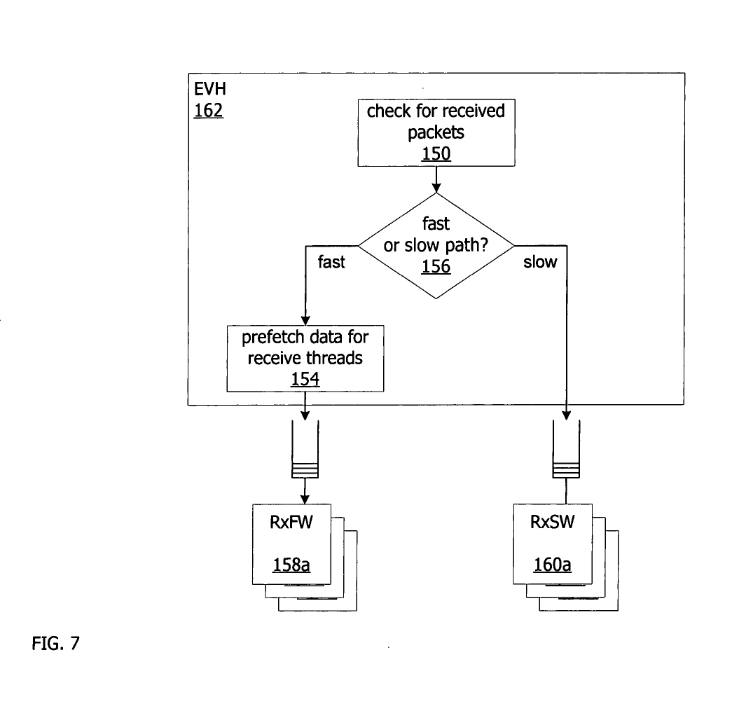

As shown in FIG. 7, a collection of CPU 112 threads 158, 160, 162 process the received packets. The collection includes threads that perform different sets of tasks. For example, slow threads 160a (RxSW) perform less time critical tasks such as connection setup, teardown, and non-data control (e.g., SYN, FIN, and RST packets) while fast threads 160 (RxFW) handle “data plane” packets carrying application data in their payloads and ACK packets. An event handler thread 162 directs packets for processing by the appropriate class of thread 158, 160. For example, as shown, the event handler thread 162 checks 150 for received packets, for example, by checking the packet descriptor queue (RxDR) 132 for delivered packets. For each packet, the event handler 162 determines 156 whether the packet should be enqueued for fast 158 or slow 160 path thread processing. As shown, the event handler 162 may fetch 154 data that will likely be used by the processing threads 158. For example, for fast path processing, the event handler 162 may fetch information used in looking up the TCB associated with the packet's connection. In the event that the NIC signaled receipt of multiple packets, the event handler 162 can “run ahead” and initiate the fetch for each packet descriptor. While the first fetch may not complete before a packet processing thread begins, fetches for the subsequent packets may complete in time. The event handler 162 may handle other tasks, such as waking threads 158 to handle the packets and performing other thread scheduling.

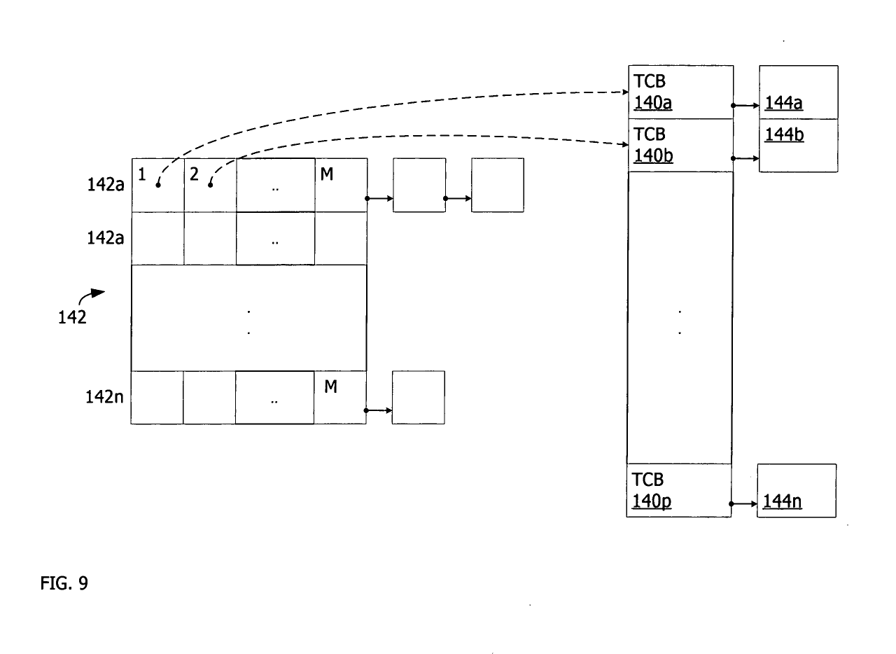

The fast threads 158 consume enqueued packets in turn. After dequeueing a packet entry, a fast thread 158 performs a lookup of the TCB for a packet's connection. A wide variety of algorithms and data structures may be used to perform TCB lookups. For example, FIG. 9 depicts data structures used in a sample scheme to access TCB blocks 140a-140p. As shown, the scheme features a table 142 of nodes. Each node (shown as a square in the table 142) corresponds to a different TCP connection and can include a reference to the connection's TCB block. The table 142 is organized as n-rows of nodes that correspond to the n-different values yielded by hashes of TCP tuples. Since different TCP tuples/connections may hash to the same value/row (a hash “collision”) each row includes multiple nodes that store the TCP tuple and a pointer to the associated TCB block 140a-140p. The table 142 allocates M nodes per row. In the event more than M collisions occur, the Mth node may anchor a linked list of additional nodes. Table 142 rows may be allocated in multiples of the processor 112 cache line size and the complete set of rows may be contained in several consecutive cache lines.

To perform a lookup, the nodes in a row identified by a hash of the packet's tuple are searched until a node matching the packet's tuple is found. The referenced TCB block 140a-140n can then be retrieved. A TCB block 140a-140n can include a variety of TCP state data (e.g., connection state, window size, next expected byte, and so forth). ATCB block 140a-140n may include or reference other connection related data such as identification of out-of-order packets awaiting delivery, connection-specific queues (e.g., a queue of pending application read or write requests), and/or a list of connection-specific timer events.

Like many TCB lookup schemes, the scheme shown may require multiple memory operations to finally retrieve a TCB block 140a-140n. To alleviate the burden of TCB lookup, a system may incorporate techniques described above. For example, NIC 102 may perform computation of the TCP tuple hash after receipt of a packet. Similarly, the event handler thread 162 may fetch data to speed the lookup. For example, the event handler 162 may fetch the table 142 row corresponding to a packet's hash value. Additionally, in the event that collisions are rare, a programmer may code the event handler 162 to fetch the TCB block 140a-140p associated with the first node of a row 142a-142n.

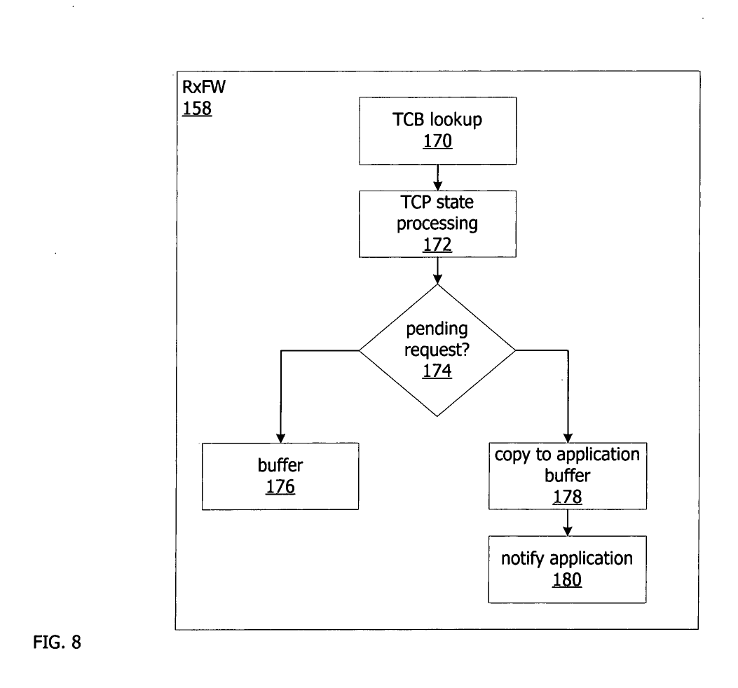

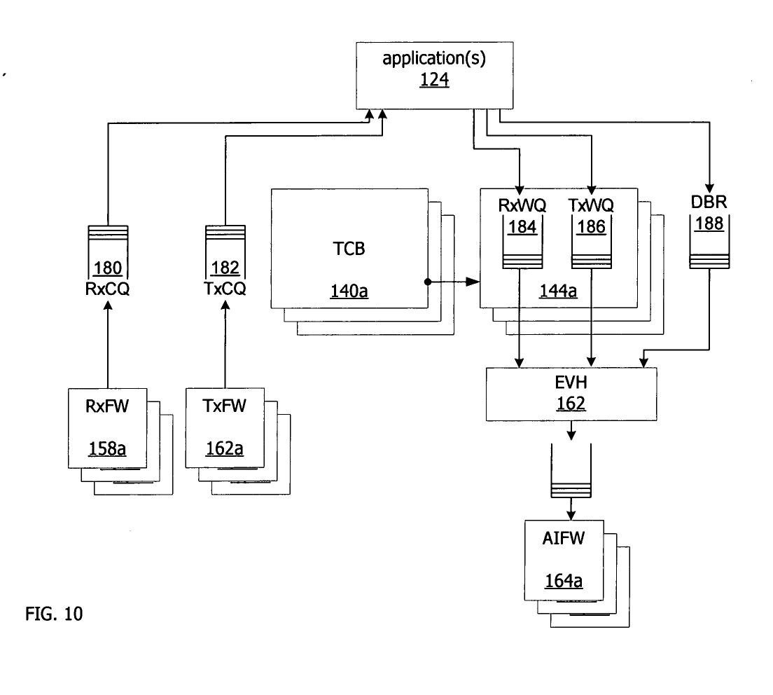

A TCB lookup forms part of a variety of TCP operations. For example, FIG. 8 depicts a process implemented by a fast path thread 158. As shown, after dequeuing a packet, the thread 158 performs a TCB lookup 170 and performs TCP state processing. Such processing can include navigating the TCP state machine for the connection. The thread 158 may also compare the acknowledgement sequence number included in the received packet against any unacknowledged bytes transmitted and associate these bytes with a list of outstanding transmit requests anchored in the connection's TCB block. Such a list may be stored in the TCB 140 and/or related data. For example, the oldest entry may be cached in the TCB 140 while other entries are stored in referenced memory blocks 144. When the last byte of a transmission is acknowledged, the receive thread can notify the requesting application (e.g., via TxCQ in FIG. 10).

The thread 158 may then determine 174 whether an application has issued a pending request for received data. Such a request typically identifies a buffer to place the next sequence of data in the connection data stream. The sample scheme depicted can include the pending requests in a list anchored in the connection's TCB block. As shown, if a request is pending, the thread can copy the payload data from the buffer(s) 136 and notify 178 the application of the posted data. To perform this copy, the thread may initiate transfer using the asynchronous memory copy (see FIG. 5A to 5C) circuitry. For packets received out-of-order or before the application has issued a request, the thread can store 176 identification of the payload buffer(s) as state data 144.

As described above, the receive threads 158 interface with an application, for example, to notify the application of serviced receive requests. FIG. 10 illustrates a sample interface between packet processing threads 158, 160, 162 and application(s) 124. As shown, fast path threads 158 can notify applications of posted data by enqueing (RxCQ) 180 entries identifying completed responses to data requests. Likewise, to request data, an application can issue an application receive request that is enqueued in a connection-specific “receive work queue” (RxWQ) 184. The RxWQ 184 may be part of the TCB 140, 144 data. A corresponding “doorbell” descriptor entry in a doorbell queue (DBR) 188 provides notification of the enqueued request to the processing threads. The descriptor entry can identify the connection and the address of buffers to store connection data. Since, the doorbell will soon be processed, the application can use direct cache access to ensure the doorbell descriptor is cached.

As shown, the event handler thread 160 monitors the doorbell queue 188 and schedules processing of the received request by an application interface thread (AIFW) 164. The event handler thread 160 may also fetch data used by the application interface threads 164 such as TCB nodes/blocks. The application interface threads 164 dequeues the doorbell entries and performs interface operations in response to the request. In the case of receive requests, an interface thread 164 can check the connection's TCB for in-order data that has been received but not yet consumed. Alternately, the thread can add the request to a connection's list 144 of pending requests in the connection's TCB.

In the case of application transmit requests, the event handler thread 126 also enqueues 186 these requests for processing by application interface threads 164. Again, the event handler 126 may fetch data (e.g., the TCB or TCB related data) used by the interface threads 164.

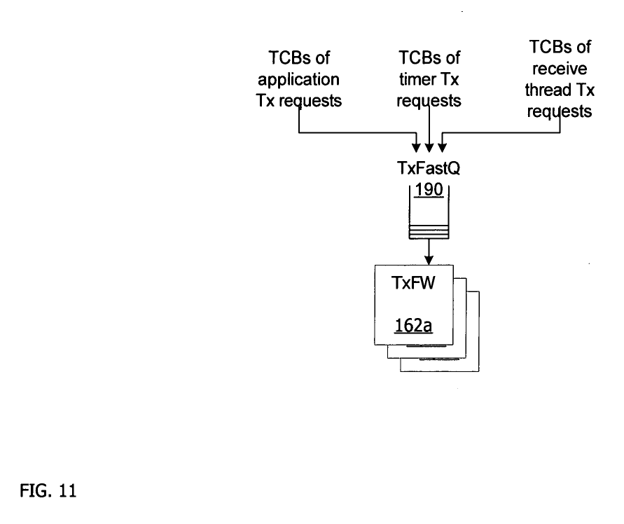

As shown in FIG. 11, in addition to application requests, transmission scheduling may also correspond to TCP timer events (e.g., a keep alive transmission, connection time-out, delayed ACK transmission, and so forth). Additionally, the receive threads 158 may initiate transmissions, for example, to ACK-nowledge received data). In the sample implementation, a transmission request is handled by queueing 190 (TxFastQ) a connection's TCB. Multiple transmit threads 162 dequeue the entries in a single producer/multi-consumer manner. Prior to dequeuing, the event handler thread 126 may fetch N-entries from the queue 190 to speed transmit thread 162 access. Alternately, the event handler 126 may maintain a “warm queue” that is a cached subset of the large volume of TxFastQ queue entries likely to be accessed soon.

The transmit threads 162 perform operations to construct a TCP/IP packet and deliver the packet to the NIC 102. Delivery to the NIC 102 is made by allocating and sending a NIC descriptor to the NIC 102. The NIC descriptor can include the payload buffer address and an address of a constructed TCP/IP header. The NIC descriptors may be maintained in a pool of free descriptors. The pools shrinks as the transmit threads 162 allocate descriptors. After the NIC issues a completion notice, for example, by a direct cache access push by the NIC, the event handler 126 may replenish freed descriptors back into the pool.

To construct a packet, a transmit thread 162 may fetch data indirectly referenced by the connection's TCB such as a header template, route cache data, and NIC data structures referenced by the route cache data. The thread 164 may yield after issuing the data fetches. After resuming, the thread 164 may proceed with TCP transmit operations such as flow control checks, segment size calculation, window management, and determination of header options. The thread may also fetch a NIC descriptor from the descriptor pool.

Potentially, the determined TCP segment size may be able to hold more data than requested by a given TxWQ entry. Thus, a transmit thread 162 may navigate through the list of pending TxWQ entries using fetch/yield to gather more data to include in the segment. This may continue until the segment is filled. After constructing the packet, the thread can initiate transfer of the packet's NIC descriptor, header, and payload to the NIC. The transmit thread 162 may also add an entry to the connection's list of outstanding transmit I/O requests and and TCP unacknowledged bytes.

In addition to the fast transmit threads 162 shown, the sample implementation may also feature slow transmit threads (not shown) that handle less time critical messaging (e.g., connection setup).

FIGS. 6-11 illustrated receive and transmit processing. The sample implementation also perform other tasks. For example, the system may feature threads to arm, disarm, and activate timers. Such timers may be queued for handling by the timer threads by the receive and/or transmit threads. The threads may operate on a global linked list of timer buckets where each bucket represents a slice of time. Timer entries are linked to the bucket corresponding to when the timer should activate. These timer entries are typically connection specific (e.g., keep-alive, retransmit, and so forth) and can be stored in the connection's TCB 140. Thus, the linked list straddles across many different TCBs. In such a scheme, arming can involve insertion into the linked last while disarming may include setting a disarm flag and/or removing from the list. The linked list insertion and deletion operations may use fetch/yield to load the “previous” and “next” nodes in the list before setting their links to the appropriate values. The timers to be inserted and/or deleted may be added to a connection's TCB and flagged for subsequent insertion/deletion into the global list by a timer thread.

The timer threads can be scheduled at regular intervals by the event handler to process the timer events. The timer threads may navigate the linked list of timers associated with a time bucket using fetch and/or fetch/yield techniques described above.

Again, while FIGS. 6-11 illustrated a sample TCP implementation, a wide variety of other implementations may use one or more of the techniques described above. Additionally, the techniques may be used to implement other transport layer protocols, protocols in other layers within a network protocol stack, and protocols other than TCP/IP (e.g., Asynchronous Transfer Mode (ATM)). Additionally, though the description narrated a sample architecture (e.g., FIG. 1) many other computer architectures may use the techniques described above such as systems with multiple CPUs or processors having multiple programmable cores integrated in the same die. Potentially, these cores may provide hardware support for multiple threads. Further, while illustrated as different elements, the components may be combined. For example, the network interface controller may be integrated into a chipset and/or into the processor

The term circuitry as used herein includes hardwired circuitry, digital circuitry, analog circuitry, programmable circuitry, and so forth. The programmable circuitry may operate on executable instructions disposed on an article of manufacture (e.g., a volatile or non-volatile storage device).

Other embodiments are within the scope of the following claims.

What is claimed is:

1. A system, comprising:
at least one processor including at least one respective cache;
at least one interface to at least one randomly accessible memory; and
circuitry to, in response to a processor request, independently copy data from a first set of locations in the randomly accessible memory to a second set of locations in the randomly accessible memory;
at least one network interface, the network interface comprising circuitry to:
signal to the at least one processor after receipt of packet data; and
initiate storage in the at least one cache of the at least one processor of at least a portion of the packet data, wherein the storage of the at least a portion of the packet data is not solicited by the processor;
instructions disposed on an article of manufacture, the instructions to cause the at least one processor to provide multiple threads of execution to process packets received by the network interface controller, individual threads including instructions to:
yield execution by the at least one processor at multiple points within the thread's flow of execution to a different one of the threads;
fetch data into the at one least one cache of the at least one processor before subsequent instructions access the fetched data;
initiate, by the circuitry to independently copy data, a copy of at least a portion of a packet received by the network interface controller from a first set of locations in the randomly accessible memory to a second set of locations in the at least one randomly accessible memory.

2. The system of claim 1, wherein the network interface circuitry further comprises circuitry to perform a hash operation on at least a portion of a received packet.

3. The system of claim 1, wherein the network interface circuitry further comprises circuitry to perform a checksum of a received packet.

4. The system of claim 1, wherein the network interface circuitry further comprises a packet buffer.

5. The system of claim 1, wherein the circuitry to independently copy data further comprises circuitry to, in response to a processor request, independently copy data from a first set of locations in a randomly accessible memory to a second set of locations in the processor cache;

6. The system of claim 1,
wherein the network interface circuitry comprises circuitry configured to signal the receipt of multiple packets; and
wherein the instructions of the threads comprise instructions to perform a fetch for multiple ones of the multiple packets.

7. The system of claim 1,
wherein the threads comprise different concurrently active flows of execution control within a single operating system process.

8. The system of claim 1,
wherein the thread instructions comprise instructions to fetch data into the at least one cache comprise at least one instruction to fetch at least a portion of a TCP Transmission Control Block (TCB).

9. The system of claim 8,
wherein the thread instructions comprise instructions to perform a thread yield immediately following execution of the at least one instruction to fetch data.

10. The system of claim 1,
wherein the threads: (1) maintain a TCP state machine for different connections, (2) generate TCP ACK messages, (3) perform TCP segment reassembly, and (4) determine a TCP window for a TCP connection.

11. The system of claim 1,
wherein the threads features different sets of thread instructions to process Transmission Control Protocol (TCP) control packets and TCP data packets.

12. The system of claim 1, wherein the at least one processor comprises a processor having multiple programmable cores integrated within the same die.

13. A system, comprising:
at least one interface to at least one processor having at least one cache;
at least one interface to at least one randomly accessible memory;
at least one network interface;
circuitry to independently copy data from a first set of locations in a randomly accessible memory to a second set of locations in a randomly accessible memory in response to a command received from the at least one processor; and
circuitry to place data received from the at least one network interface in the at least one cache of the at least one processor.

14. The system of claim 13, wherein the circuitry to place data received from the at least one network interface comprises circuitry to place at least a portion of a packet in the at least one cache of the at least one processor before a processor request to access the data.

15. The system of claim 13, wherein the command received from the at least one processor comprises a source address of a randomly accessible memory and a destination address of the at least one randomly accessible memory.

16. The system of claim 13, wherein the command comprises identification of a target device.

17. The system of claim 13, wherein the processor comprises multiple programmable cores integrated on a single die.

18. The system of claim 13, wherein the processor comprises a processor providing multiple threads of execution.

19. The system of claim 13, further comprising the at least one network interface.

20. The system of claim 13, wherein the network interface comprises circuitry to:
determine a checksum of a received packet;
hash at least a portion of the received packet; and
signal the receipt of data.

21. An article of manufacture comprising instructions that when executed cause a processor to perform operations comprising:
receiving at a processor an indication of receipt of one or more packets; and
if more than one packet was received, fetching at least the headers of multiple ones of the more than one packet into a cache of the processor before instructions executed by the processor operate on all of the headers of the multiples ones of the more than one packet.

22. The article of claim 21,
wherein the one or more packets comprise Transmission Control Protocol/Internet Protocol (TCP/IP) packets; and
further comprising instructions to perform operations comprising fetching at least one selected from the group of: (1) a reference to Transmission Control Blocks (TCBs) of the respective TCP/IP packets; and (2) the TCBs of the respective TCP/IP packets.

23. The article of claim 21, further comprising instructions to perform operations comprising initiating independent copying of a packet payload to an application specified address by memory copy circuitry.

24. An article of manufacture comprising instructions that when executed cause a processor to perform operations comprising:
providing multiple threads of execution of at least one set of instructions, at least one of the set of instructions comprising:
multiple yields of execution to a different one of the multiple threads;
multiple fetches to load data into a processor cache, the data fetched comprising data selected from the following group: (1) a reference to a Transmission Control Block (TCB) of a Transmission Control Protocol/Internet Protocol (TCP/IP) packet; (2) a TCB of a TCP/IP packet; and (3) a header of a TCP/IP packet.

25. The article of claim 23, further comprising instructions that when executed initiate an independent copy operation of a TCP/IP packet payload by copy circuitry asynchronous to a processor executing the multiple threads.

26. The article of claim 23,
wherein the instructions comprise at least two sets of thread instructions to process received Transmission Control Protocol (TCP) segments, the two sets of thread instructions including at least one set of thread instructions to process TCP control segments and at least one set of thread instructions to process TCP data segments; and
further comprising instructions to perform operations comprising determining whether a TCP segment is a TCP control segment or a TCP data segment.

27. A method comprising:
at a network interface controller:
receiving at least one link layer frame, the link layer frame encapsulating at least one Transmission Control Protocol/Internet Protocol packet;
determining a checksum for the at least one encapsulated Transmission Control Protocol/Internet Protocol packet;
determining a hash based on, at least, a source Internet Protocol address, a destination Internet Protocol address, a source port, and a destination port identified by an Internet Protocol header and a Transmission Control Protocol header of the Transmission Control Protocol/Internet Protocol packet;
signaling an interrupt to at least one processor after receipt of at least a portion of the at least one link layer frame;
initiating placement of, at least, the Internet Protocol header and the Transmission Control Protocol header into a cache of the at least one processor prior to a processor request to access a memory address identifying storage of the Internet Protocol header and the Transmission Control Protocol header;
at circuitry interconnecting the processor, the network interface controller, and at least one randomly accessible memory:
receiving a request from the processor to independently transfer at least a portion of a payload of a Transmission Control Protocol segment from a first set of memory locations in a randomly accessible memory to a second set of memory locations in the at least one randomly accessible memory;
at the processor:
providing multiple threads of execution, wherein individual ones of the multiple threads execute a set of instructions to perform operations that include:
at least one yield of execution to a different one of the multiple threads; and
at least one fetch to load data into a processor cache, the data fetched selected from the following group: (1) a reference to Transmission Control Blocks (TCBs) of the a Transmission Control Protocol/Internet Protocol (TCP/IP) packet; (2) the TCB of a TCP/IP packet; and (3) a header of a TCP/IP packet

28. The method of claim 27, wherein the multiple threads of execution comprise multiple ones of the multiple threads within a same operating system process.

29. The method of claim 27, wherein the request from the processor to independently transfer at least a portion of a payload of a Transmission Control Protocol segment from a first set of memory locations in a randomly accessible memory to a second set of memory locations in the at least one randomly accessible memory caused the payload to be transferred directly to the cache of a processor.

30. A system comprising:
a network interface, the network interface comprising circuitry to:
receive at least one link layer frame, the link layer frame encapsulating at least one Transmission Control Protocol/Internet Protocol packet;
determine a checksum for the Transmission Control Protocol/Internet Protocol packet;
determine a hash based on, at least, a source Internet Protocol address, a destination Internet Protocol address, a source port, and a destination port identified by an Internet Protocol header and a Transmission Control Protocol header of the Transmission Control Protocol/Internet Protocol packet;
signal to at least one processor after receipt of at least a portion of the at least one link layer frame;
initiate placement of, at least, the Internet Protocol header and the Transmission Control Protocol header into a cache of the at least one processor prior to a processor request to access a memory address identifying storage of the Internet Protocol header and the Transmission Control Protocol header;
circuitry interconnecting the processor, the network interface, and at least one randomly accessible memory, the circuitry comprising circuitry to:
receive a request from the processor to independently transfer at least a portion of a payload of a Transmission Control Protocol segment from a first set of memory locations in a randomly accessible memory to a second set of memory locations in the at least one randomly accessible memory;
the processor including the at least one cache; and
an article of manufacture comprising instructions that when executed cause a processor to perform operations comprising:
providing multiple threads of execution, wherein individual ones of the multiple threads execute a set of instructions to perform operations that include:
multiple yields of execution to a different one of the multiple threads; and
multiple fetches to load data into a processor cache, the data fetched selected from the following group: (1) a reference to Transmission Control Blocks (TCBs) of the a Transmission Control Protocol/Internet Protocol (TCP/IP) packet; (2) the TCB of a TCP/IP packet; and a header of a TCP/IP packet

31. The system of claim 30, wherein the multiple threads of execution comprise multiple ones of the multiple threads within a same operating system process.
